(19) United States
(12) Patent Application Publication
(10) Pub. No.: US 2001/0028283 A1
(43) Pub. Date: Oct. 11, 2001

(54) DIRECTIONAL COUPLER

(76) Inventors: YUTAKA SASAKI, NAGAKAKYO-SHI (JP); HIROAKI TANAKA, MISHIMA-GUN (JP)

Correspondence Address: OSTROLENK FABER GERB & SOFFEN, 1180 AVENUE OF THE AMERICAS, NEW YORK, NY, 100368403

(21) Appl. No.: 09/205,864

(22) Filed: Dec. 4, 1998

(30) Foreign Application Priority Data
Dec. 5, 1997 (JP) 9-335821

(51) Int. Cl. H01P 5/18

(52) U.S. Cl. 333/116; 333/117

(57) ABSTRACT

First and second microstriplines 2 and 3 disposed substantially in parallel to each other and coupled with each other are formed spirally in a substantially quadrangular shape with the first microstripline 2 being disposed inside. The space between the first and second microstriplines 2 and 3 at portions disposed adjacently with the same number of turns is set longer than the space between the first and second microstriplines 2 and 3 at portions disposed adjacently with different numbers of turns.

### BACKGROUND OF THE INVENTION

1. Field of the Invention

The present invention relates to directional couplers, and more particularly, to a directional coupler used for a mobile communication apparatus.

2. Description of the Related Art

FIG. 4 shows a conventional directional coupler. In FIG. 4, a directional coupler 20 is formed of a first microstripline 21 serving as a first distributed-constant line and a second microstripline 22 serving as a second distributed-constant line disposed substantially in parallel to each other, coupled with each other, and formed spirally in a substantially quadrangular shape with the first microstripline 21 being disposed inside. The first microstripline 21 is connected to an input electrode 23 at one end and to an output electrode 25 at the other end. The second microstripline 22 is connected to an output electrode 24 at one end and to an isolation electrode 26 at the other end. The space g4 between the first and second microstriplines 21 and 22 disposed adjacently with the same number of turns is set narrower than the space d4 between the first and second microstriplines 21 and 22 disposed adjacently with different numbers of turns. The lengths of the first and second microstriplines 21 and 22 are set substantially equal to one fourth the wavelength at the target frequency.

When a signal is input to the input electrode 23 with a terminating resistor (not shown) being connected to the isolation electrode 26 in the directional coupler 20 configured as described above, two signals with a phase difference of approximately 90 degrees are obtained from the output electrodes 24 and 25 at substantially the same level.

In the conventional case, however, the second microstripline 22 is longer than the first microstripline 21 by the lengths of several corners. Therefore, the phase difference between the two outputs of the directional coupler 20 shifts from the ideal state, namely, 90 degrees.

### SUMMARY OF THE INVENTION

Accordingly, it is an object of the present invention to provide a directional coupler which can reduce a shift of the phase difference between two outputs from 90 degrees.

The foregoing object is achieved according to the present invention through the provision of a directional coupler in which first and second distributed-constant lines disposed substantially in parallel to each other and coupled with each other are formed spirally with the first distributed-constant line being disposed inside, wherein the space between the first and second distributed-constant lines disposed adjacently with the same number of turns is set wider than the space between the first and second distributed-constant lines disposed adjacently with different numbers of turns.

The directional coupler according to the present invention may be provided with a portion where the space between the first and second distributed-constant lines disposed adjacently with the same number of turns is set wider than the space between the first and second distributed-constant lines disposed adjacently with different numbers of turns.

With such a configuration, a deviation from 90 degrees of the phase difference between two outputs can be reduced in a directional coupler according to the present invention.

According to a directional coupler of the present invention, since the first and second distributed-constant lines disposed substantially in parallel to each other and coupled with each other are formed with the first distributed-constant line being disposed inside; and the space between the first and second microstriplines disposed adjacently with the same number of turns is made even-partially wider than the space between the first and second microstriplines disposed adjacently with different numbers of turns, a shift of the phase difference between the two outputs of the directional coupler from 90 degrees is made small, and the frequency band width of the directional coupler is made wide. In addition, the space between the first and second microstriplines disposed adjacently with the same number of turns can be changed in a wide range, and the coupling degree of the directional coupler becomes easier to adjust.

### BRIEF DESCRIPTION OF THE DRAWINGS

FIG. 1 is a view showing a configuration of a directional coupler according to an embodiment of the present invention.

FIG. 2 is a view indicating the phase difference between two outputs of the directional coupler of FIG. 1.

FIG. 3 is a view showing a configuration of another directional coupler according to an embodiment of the present invention.

FIG. 4 is a view of a configuration of a conventional directional coupler.

### DESCRIPTION OF THE PREFERRED EMBODIMENTS

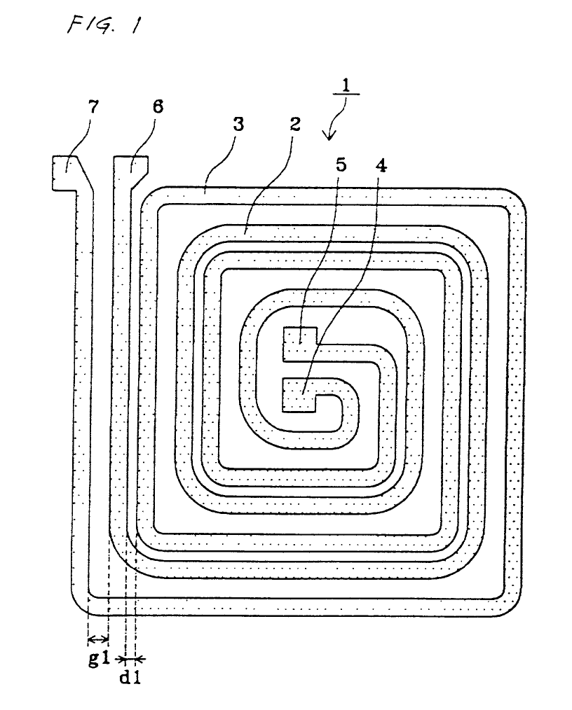

FIG. 1 shows a directional coupler according to an embodiment of the present invention. In FIG. 1, a directional coupler 1 is formed of a first microstripline 2 serving as a first distributed-constant line and a second microstripline 3 serving as a second distributed-constant line disposed substantially in parallel to each other, coupled with each other, and formed spirally in a substantially quadrangular shape with the first microstripline 2 being disposed inside. The first microstripline 2 is connected to an input electrode 4 at one end and to an output electrode 6 at the other end. The second microstripline 3 is connected to an output electrode 5 at one end and to an isolation electrode 7 at the other end. The space g1 between the first and second microstriplines 2 and 3 disposed adjacently with the same number of turns is set wider than the space d1 between the first and second microstriplines 2 and 3 disposed adjacently with different numbers of turns. The lengths of the first and second microstriplines 2 and 3 are set substantially equal to one fourth the wavelength at the target frequency.

When a signal is input to the input electrode 4 with a terminating resistor (not shown) being connected to the isolation electrode 7 in the directional coupler 1 configured as described above, two signals with a phase difference of approximately 90 degrees are obtained from the output electrodes 5 and 6 at substantially the same level.

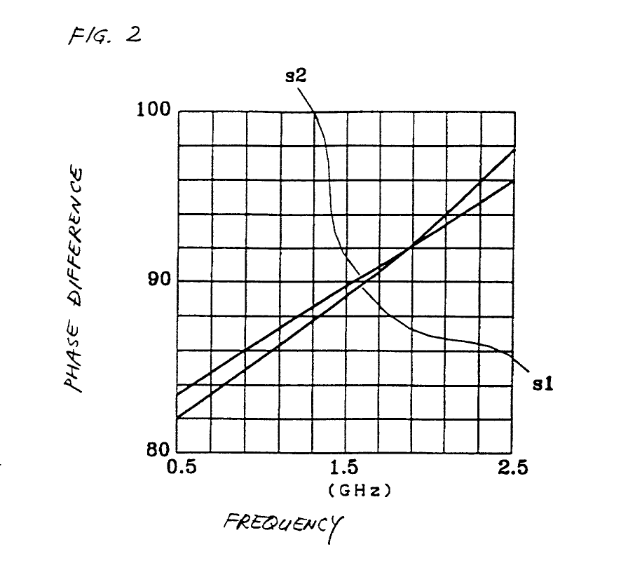

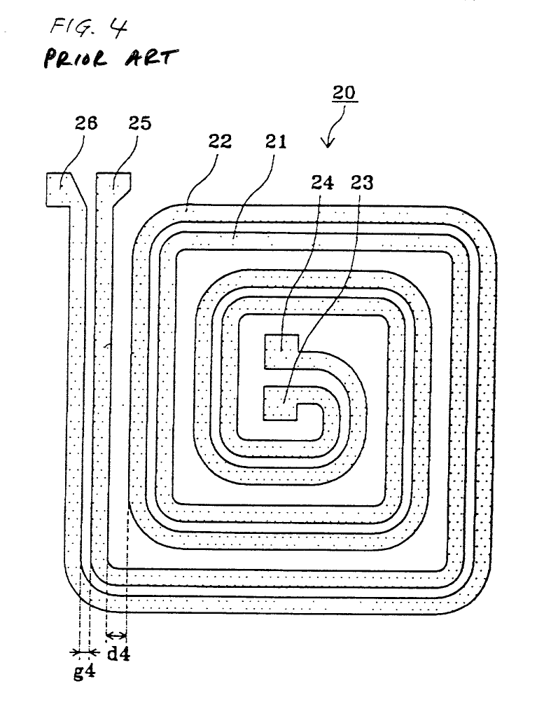

FIG. 2 shows the phase difference s2 between the two outputs of the directional coupler 1 shown in FIG. 1. For comparison, the phase difference s1 between the two outputs of the directional coupler 20 shown in FIG. 4 is also shown. Both directional couplers are designed at a center frequency of 1.5 GHz. It is understood from FIG. 2 that the phase difference s2 between the two outputs is closer to 90 degrees than the phase difference s1, and is approximately 89 degrees. The gradient of a phase difference to a frequency is slightly gentler at the phase difference s2 than at the phase difference s1. This means that the directional coupler 1 maintains a phase difference of approximately 90 degrees at a wider frequency band than the directional coupler 20, and the directional coupler 1 operates as a wide-band directional coupler.

Since the phases of signals are shifted from each other on the first and second microstriplines 2 and 3 disposed adjacently with different numbers of turns, even if the space d1 is made narrower, both signals are unlikely to be coupled with each other. When the space d1 is made narrower, the space g1 between the first and second microstriplines 2 and 3 disposed adjacently with the same number of turns can be changed in a wider range without changing the entire size of the directional coupler, and the coupling degree of the directional coupler 1 becomes easier to adjust.

As described above, according to the directional coupler 1 of the present invention, the space g1 between the first and second microstriplines 2 and 3 disposed adjacently with the same number of turns is made wider than the space d1 between the first and second microstriplines 2 and 3 disposed adjacently with different numbers of turns, and thereby a deviation from the phase difference, that is 90 degrees of phase difference, between the two outputs of the directional coupler 1 from 90 degrees is made small. In addition, the frequency band of the directional coupler is made wide and the coupling degree thereof becomes easier to adjust.

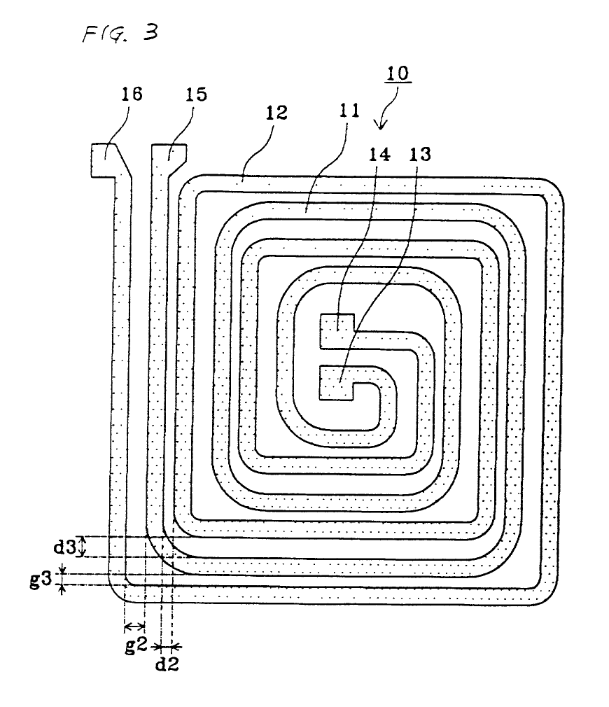

FIG. 3 shows a directional coupler according to another embodiment of the present invention. In FIG. 3, a directional coupler 10 is formed of a first microstripline 11 serving as a first distributed-constant line and a second microstripline 12 serving as a second distributed-constant line disposed substantially in parallel to each other, coupled with each other, and formed spirally in a substantially quadrangular shape with the first microstripline 11 being disposed inside. The first microstripline 11 is connected to an input electrode 13 at one end and to an output electrode 15 at the other end. The second microstripline 12 is connected to an output electrode 14 at one end and to an isolation electrode 16 at the other end. In the vertical direction in FIG. 3, the space g2 between the first and second microstriplines 2 and 3 disposed adjacently with the same number of turns is set wider than the space d2 between the first and second microstriplines 2 and 3 disposed adjacently with different numbers of turns. In the horizontal direction in FIG. 3, the space g3 between the first and second microstriplines 2 and 3 disposed adjacently with the same number of turns is set narrower than the space d3 between the first and second microstriplines 2 and 3 disposed adjacently with different numbers of turns. The lengths of the first and second microstriplines 11 and 12 are set substantially equal to one fourth the wavelength at the target frequency. Since the operation of the directional coupler 10 is the same as that of the directional coupler 1 shown in FIG. 1, the description thereof is omitted.

As described above, the space between the first and second microstriplines disposed adjacently with the same number of turns is made partially wider than the space between the first and second microstriplines disposed adjacently with different numbers of turns, and thereby a shift of the phase difference between the two outputs of the directional coupler 10 from 90 degrees is made small, as in the case shown in FIG. 1. In addition, the frequency band of the directional coupler is made wide.

In each of the above embodiments, the directional coupler is formed spirally in a substantially quadrangular shape. The shape is not limited to a substantial quadrangle. The same operation and advantages can be obtained with other shapes, such as a substantial polygon, a substantial circle, and a substantial ellipse.

In each of the above embodiments, among the two input electrodes, one is connected to a terminating resistor and a signal is input to the other. The connections may be reversed. In addition, the input electrodes and the output electrodes may be used vice versa. In other words, in each of the above embodiments, a signal may be input to either of the output electrodes to obtain two output signals from the input electrodes.

In each of the above embodiments, a microstripline is used as a distributed-constant line.

Other distributed-constant lines such as a stripline may be used instead.

What is claimed is:

1. A directional coupler in which first and second distributed-constant lines disposed substantially in parallel to each other and coupled with each other are formed spirally with the first distributed-constant line being disposed inside,
wherein the space between the first and second distributed-constant lines disposed adjacently with the same number of turns is set wider than the space between the first and second distributed-constant lines disposed adjacently with different numbers of turns.

2. A directional coupler according to claim 1, wherein said first and second distributed-constant lines are provided with a portion where the space between the first and second distributed-constant lines at portions disposed adjacently with the same number of turns is set wider than the space between the first and second distributed-constant lines disposed adjacently with different numbers of turns.
